(19) United States
(12) Patent Application Publication
(10) Pub. No.: US 2009/0311523 A1
(43) Pub. Date: Dec. 17, 2009

(54) Bulletproof glass safety system

(76) Inventor: Keith Friedman, Santa Barbara, CA (US)

Correspondence Address: MARK RODGERS, 1590 SAN ROQUE ROAD, SANTA BARBARA, CA, 93105, US

(21) Appl. No.: 12/214,255

(22) Filed: Jun. 16, 2008

(51) Int. Cl. B32B 17/10

(52) U.S. Cl. 428/339; 428/441

(57) ABSTRACT

A window system, incorporating an outer bulletproof glass layer coupled with a standoff system and an inner laminate glass layer, delivers greatly improved occupant safety in vehicle accidents compared to bulletproof glass alone

### RELATED APPLICATIONS

Not Applicable

### FEDERALLY SPONSORED RESEARCH

Not Applicable

### SEQUENCE LISTING

Not Applicable

### BACKGROUND OF THE INVENTION

This application relates to bulletproof glass windows in vehicles and specifically a novel system to address the safety issues associated with bulletproof glass windows in vehicle accidents.

Bulletproof glass has been used for many years in vehicles such as armored bank vehicles for the transport of money. More recently, the use of bulletproof glass has increased in executive and government vehicles, particularly as an anti-terrorism measure. The occupants of these and other vehicles with such glass typically are not wearing helmets. If side curtain airbags are not provided in such vehicles, occupants of these vehicles can have significant head impacts with the bulletproof glass during motor vehicle accidents. Bulletproof side windows, typically with thicknesses in the range of 20 mm, present unforgiving impact surfaces in front oblique, rollover and side impacts. If occupant protection system designs do not provide sufficient lateral restraint to prevent injurious head impact with the bullet proof glass through use of side curtains or other design approaches, a passive impact protection system is desirable

A layer of energy absorbent material placed on the inboard side of a bulletproof window is a possible passive solution, but the choices for such a material are limited. To be acceptable, the material must be clear and not distort vision through the window. Known materials with the required energy absorbent properties and clarity tend to scratch easily and/or yellow or become opaque with age, and thus are not suitable for vehicle applications. What is needed is a passive restraint system that retains the durability and optical properties of window glass.

### BRIEF SUMMARY OF THE INVENTION

The invention is a window system for a vehicle, including an outboard layer of bullet-proof glass, a stand-off layer inboard of the bullet-proof glass layer, and an inner layer of laminate safety glass inboard of the standoff-layer. The laminate safety glass is typically a plastic interlayer sandwiched between two glass layers.

In particular tested embodiments the plastic interlayer is PVB and the glass layer thickness is approximately 2 to 2.5 mm while the PVB interlayer thickness is between approximately 0.75 and 1.5 mm.

In other embodiments an energy absorbing material may be used around the perimeter of the stand-off region, providing the stand-off connection between the bullet proof glass and laminate glass layers, and/or the bullet-proof glass layer and the laminate safety glass layer may connected by energy-absorbing stand-offs. The system may further include exterior padding around the rim of the inboard side of the laminate safety glass layer, particularly desirable for the case where stiff stand-offs are employed. Typically it may also be desirable to include venting of the standoff layer.

### BRIEF DESCRIPTION OF THE DRAWINGS

The invention will be better understood by referring to the following figures.

FIG. 1 depicts the basic elements of the invention.

FIG. 2 shows the details of the laminate safety glass.

FIG. 3 is a Finite Element model of portions of the invention in operation

FIG. 4 shows an embodiment of the invention including energy absorbing material on the perimeter of the stand-off region

FIG. 5 shows an embodiment of the invention including energy absorbent stand-offs used to separate the two glass sections FIG. 6 depicts an embodiment with rim of energy absorbing material around the inboard layer.

### DETAILED DESCRIPTION OF THE INVENTION

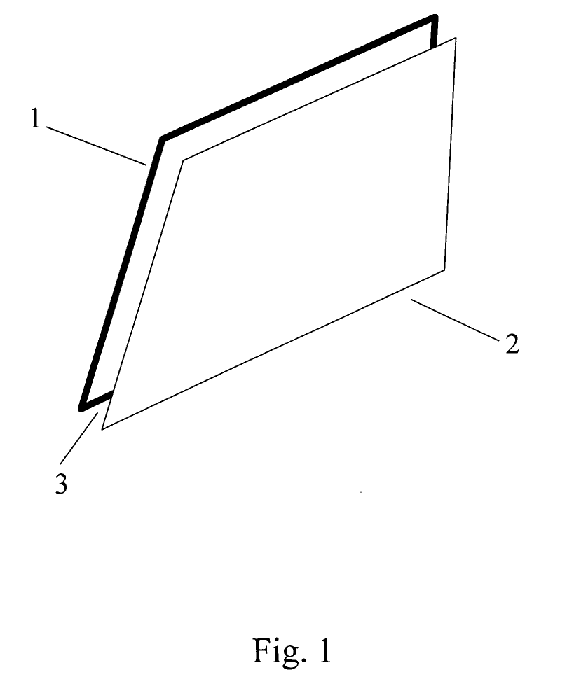

The invention in it's broadest form, illustrated in FIG. 1 incorporates a layer of laminated safety glass 2 with a standoff region 3 inboard of the bulletproof glass layer 1. Such a window system provides a more compliant and energy absorbing contact surface than bulletproof glass alone. If the gap between the bulletproof window and the laminated glass is sufficient, the energy absorbed by glass fracture and plastic deformation of the interlayer can significantly reduce the impact velocity of the head with the bulletproof glass or prevent contact altogether. In order to most conveniently be used in place of existing bullet-proof glass installations with little modification, it is envisioned that the laminate glass layer can be attached to the bullet-proof glass layer, as will be described below, either to an existing bulletproof layer, or as an assembly that can be used in place of a single bulletproof glass layer. For these cases, the inner safety layer is attached to the bulletproof glass layer across the stand-off region. It is also within the capability of one skilled in the art to envision a range of mounting frame possibilities for cases where the novel window system is designed in for a new or modified vehicle.

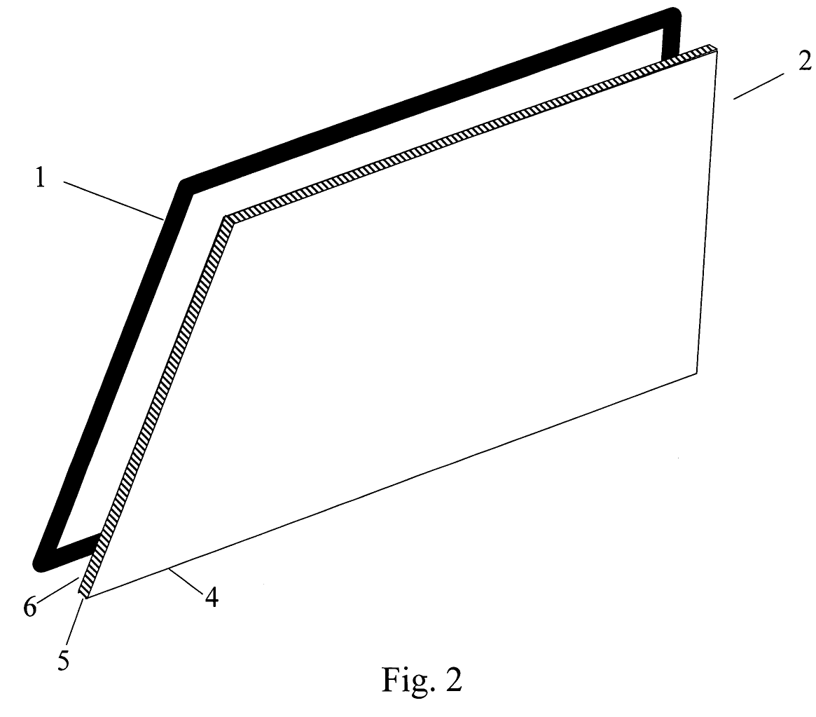

The laminate safety glass may be of a type already used in the automotive industry. Such window glass as shown in FIG. 2, consists of two glass layers 4 and 6 which are formed into a sandwich about interlayer 5 commonly consisting of polyvinyl butyral (PVB). Such glass is typically constructed with the glass layers of thickness in the 2 mm range, and the PVB interlayer in the 0.75 mm range. Other materials and dimensions are possible as will be discussed below. It is known that the thinness of the glass layers provides a survivable head impact scenario, while the sandwich construction around the soft PVB interlayer provides overall structural strength along with relatively safe fracture characteristics. Such glass laminates are increasingly used in window and windshield design for vehicles, and are many times less dangerous in head impacts than 20 mm bulletproof glass, yet are perfectly acceptable optically and from a durability standpoint.

Since typical bullet proof glass is 20 mm thick, and common laminate safety glass is about 5 mm thick, an overall width for the system was chosen as about 75 mm, to avoid an impractically thick overall window system, indicating a desired standoff gap in the 50-65 mm range.

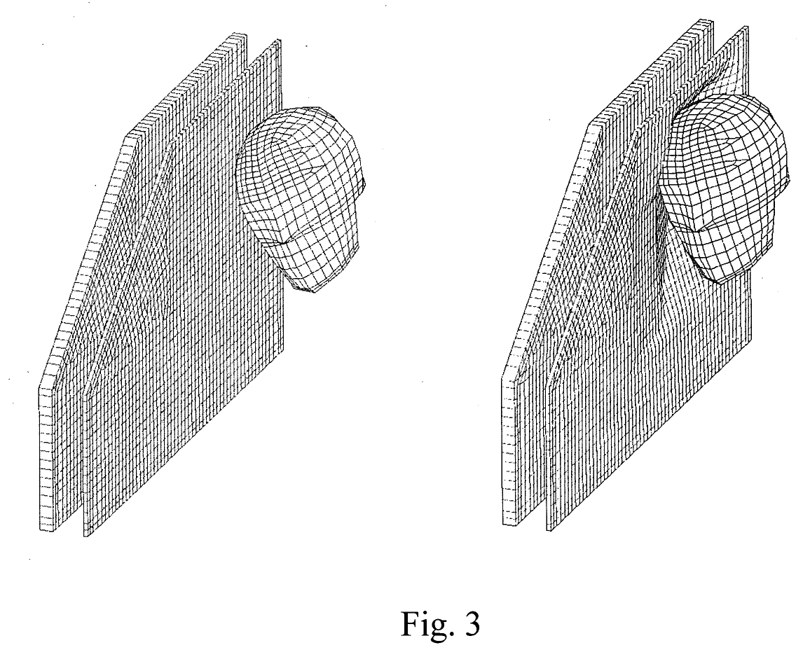

Using a variety of dimensions in the ranges above, Hybrid III dummy headform impacts were simulated using the LS-DYNA finite element program. A model of a Hybrid III headform developed by Livermore Software Technology Corp.(LSTC) was modified to improve correlation with head acceleration data from a 0.65 meter drop test of a Hybrid III headform on the top of the head. The model was also shown to meet peak acceleration requirements for a 2.7 m/s forehead impact for the headform validation portion of the FMVSS 201 occupant protection standard. A 19 mm-thick bulletproof window design was modeled, as well as various laminated glass panels with the same shape as the bulletproof window. The laminated glass was fixed inboard of the bulletproof window by perimeter standoffs of various heights within the above ranges dictating the gap between the laminated glass and the bulletproof window. The laminated window designs considered consisted of a typical interlayer of polyvinyl butyral (PVB) sandwiched between two identical plates of glass. The laminated glass finite element model was validated with force-deflection data from various quasi-static ring-on-ring bending tests. 15-mph lateral head impacts with various bulletproof window systems were simulated. The impacts were centered on the upper rear quadrant of the window, and the headform was tilted laterally 27 degrees from vertical. The strain-rate dependent PVB stress-strain properties were selected based on the strain rates seen in the laminated glass during failure in the 15-mph impacts. A depiction of the modeling is shown in FIG. 3. For baseline comparison, a 15-mph impact with the unprotected bulletproof window was simulated that produced excessive head injury criterion (HIC) and peak head accelerations. For the range of system designs considered, it was found that a window spacing of about 50-65 mm was sufficient to keep HIC levels well below head injury thresholds for the 15-mph lateral impact modeled.

In order to keep the stand-off gap around 50-65 mm it was found that thicker than standard PVB interlayers are desirable. However sticking with the common glass layer thicknesses, in the 2 mm range, such laminate glass with thicker PVB interlayers is easily obtainable from existing sources. However thinner glass designs, alternate glass materials, thicker interlayers or interlayers of alternate materials are also possible. Glass alternatives include polycarbonates, glass-plastic, or plastic-composites. Alternative interlayer materials include Surlyn and Sentryglas-Plus. Use of alternative materials may allow for thinner laminates and/or thinner stand-off gaps. However, the commonly available Glass-PVB-Glass laminates in the dimensions tested produce acceptable results

Example results shown in the table below of selected laminated glass lay-ups and window spacings show that for PVB based formulations 50-57 mm gaps provide substantial improvements in head injury measures. In this table the HIC and peak acceleration values are normalized to the baseline unprotected bulletproof window values. A lay-up designation of 2.4/1.14/2.4 refers to a laminate with 1.14 mm of PVB sandwiched between two 2.4 mm plates of glass, and so on. Of those alternatives shown the 2.4/1.14/2.4 laminate with 57 mm spacing had performance almost 40 times better than the baseline. The same design also performed well for a 15-mph head impact located at the center of window (normalized peak acceleration and HIC of 0.312 and 0.073 respectively).

| | 50.8 mm gap | | 57.2 mm gap | |
|---|---|---|---|---|
| Laminated | normalized | normalized | normalized | normalized |
| Glass Lay-up | peak acc | HIC | peak acc | HIC |
| 2.1/1.52/2.1 | 0.340 | 0.081 | 0.115 | 0.025 |
| 2.4/1.14/2.4 | 0.310 | 0.067 | 0.232 | 0.041 |

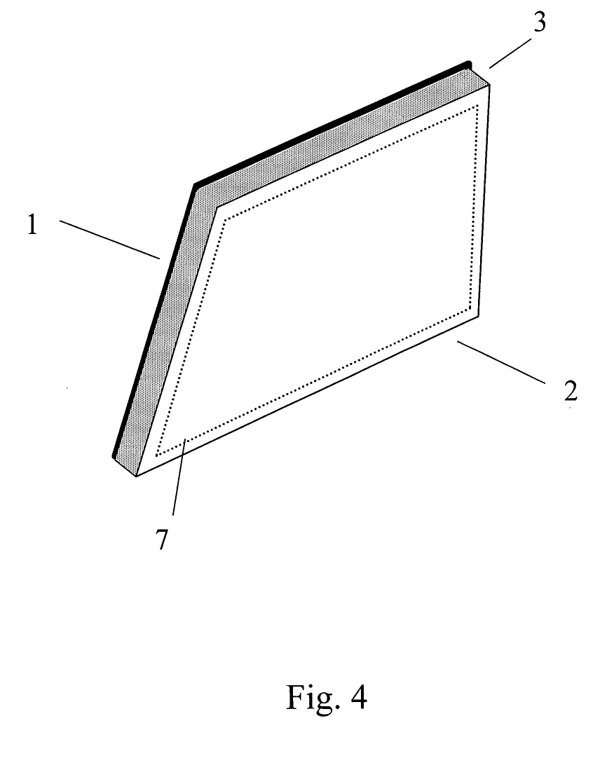

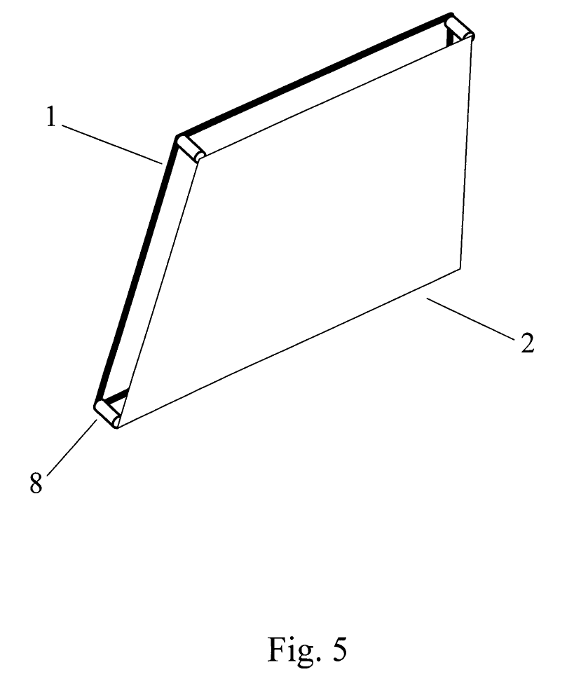

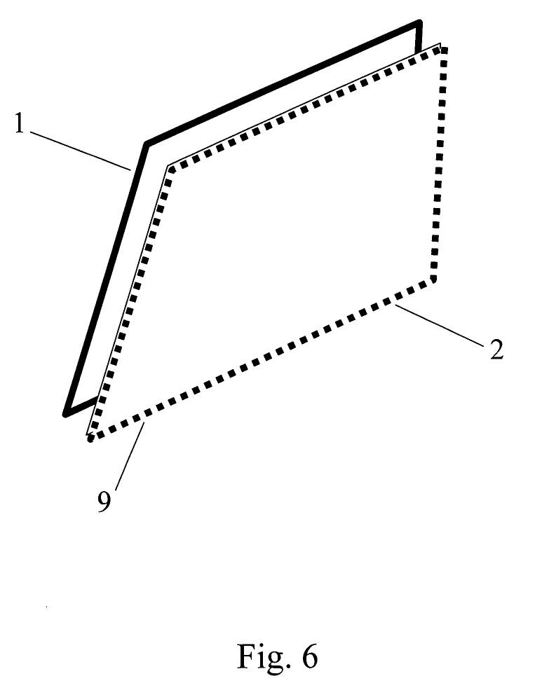

Alternative stand-off arrangements are possible which may lead to either decreased overall stand-off width, or increased head impact protection. As shown in FIG. 4, the standoff layer 3 could have an energy absorbent material 7 installed around the perimeter of the window and providing the stand-off connection between the bullet-proof layer and the laminate layer. It is also possible to employ a clear energy absorbing material and fill the stand-off region. In this case, the glass layers would protect against scratching and aging of the clear stand-off material. Or, as shown in FIG. 5 perimeter standoffs 8 could be used. The perimeter standoffs between the bulletproof glass and laminate layer could be constructed of energy absorbing material such as honeycomb to absorb impacts on the edge of the window. Alternatively, a variety of materials including metal, foam, rubber, composite, or plastic perimeter standoffs in various physical shapes could be employed. If a stiff stand-off is employed then as shown in FIG. 6, exterior padding 9 around the perimeter in conjunction with the mounting assembly would be desirable to protect against impacts with the window edge. To prevent condensation in the chamber between the windows, the standoff should be provided with vent holes. The window chamber could also be incorporated into the vehicle defroster system. Costs for the improved performance are low compared to the costs for the bulletproof glass itself.

The novel bulletproof window system has been shown to provide up to a 40 times reduction in HIC levels over unprotected bulletproof glass for the 15-mph impacts simulated. The system design is modular and provides for insertion into the vehicle in a way that is compatible with current assembly techniques for insertion of bulletproof glass modules. Costs are similar to the original bullet proof glass costs since the material and module assembly costs are low. Improved performance can be provided with alternate interlayer materials. Other glass plastic, plastic, composite, plastic composite structures can be utilized for the inner layer.

We claim:

1. A window system for a vehicle, comprising;
an outboard layer of bullet-proof glass,
a stand-off layer inboard of the bullet-proof glass layer, and;
an inner layer of laminate safety glass inboard of the standoff-layer.

2. The window system of claim 1 wherein the laminate safety glass comprises a plastic interlayer sandwiched between two glass layers.

3. The window system of claim 2 wherein the plastic interlayer is PVB.

4. The window system of claim 1 wherein an energy absorbing material is placed around the perimeter of the stand-off layer, thereby providing the stand-off connection between the layers.

5. The window system of claim 3 wherein the glass layer thickness is between 2 and 2.5 mm and the PVB layer thickness is between approximately 0.75 and 1.5 mm.

5. The window system of claim 1 wherein the bullet-proof glass layer and the laminate safety glass layer are connected by energy-absorbing stand-offs.

6. The window system of claim 1 further comprising exterior padding around the rim of the inboard side of the laminate safety glass layer.

7. The window system of claim 1 further comprising venting of the standoff layer.
